(19) United States
(12) Patent Application Publication
(10) Pub. No.: US 2026/0071482 A1
(43) Pub. Date: Mar. 12, 2026

(54) SECURITY SCREEN

(71) Applicant: CLEARSHIELD SECURITY PTY LTD, Malaga (AU)

(72) Inventor: Jamie Dimitrios Elias Koutsoukos, Ellenbrook (AU)

(73) Assignee: CLEARSHIELD SECURITY PTY LTD, Malaga, WA (AU)

(21) Appl. No.: 19/105,905

(22) PCT Filed: Aug. 23, 2023
(86) PCT No.: PCT/AU2023/050813

§ 371 Date: Feb. 24, 2025

(30) Foreign Application Priority Data
Aug. 24, 2022 (AU) 2022902424

(51) Int. Cl. E06B 5/10

(52) U.S. Cl. CPC E06B 5/10

(57) ABSTRACT

The present invention provides a security screen (10) for securing an opening. The security screen comprising a frame (11) defining an open portion (12) and a sheet element (29) received across the open portion of the frame. The sheet element comprises a planar portion (52) and an edge portion (54) which extends around the perimeter of the planar portion. The edge portion provides a lip (56) which is at an acute angle to the planar portion. The edge portion is received in a cavity in the frame wherein the cavity maintains the lip at an acute angle to the planar portion regardless of an impact thereon.

### CROSS-REFERENCE TO RELATED APPLICATIONS

This application is a U.S. national stage application under 35 U.S.C. § 371 that claims the benefit of priority under 35 U.S.C. § 365 of International Patent Application No. PCT/AU2023/050813, filed on Aug. 23, 2023, designating the United States of America, which in turn claims the benefit of priority under 35 U.S.C. §§ 119, 365 of Australian Patent Application No. 2022902424, filed Aug. 24, 2022, the contents of which are relied upon and incorporated herein by reference in their entirety.

### FIELD OF THE DISCLOSURE

The present disclosure generally relates to security screens. In particular the present disclosure relates to security screens which are mounted across openings, such as doorways, and windows to secure the opening.

### BACKGROUND

Security screens compromise a sheet element secured between a frame, and generally take the form of screens which are mounted across openings such as windows and doorways. The security screen allows the flow of air and light therethrough while not unduly restricting the vision through the opening, they prevent the entry of insects into a building, and prevent unauthorized access through the opening. In relation to doorways, security screens comprise screen doors which are used in association with externally facing doorways and may be opened or closed. An example of such a security screen is disclosed in Australian Patent 2005252260 Security Screen to the present applicant.

While the security screen of patent AU2005252260 provides a robust security screen it was identified that the security screen needed additional reinforcement to ensure the security screen was able to withstand impact of 200 joule. Without the additional reinforcement the sheet element, after experiencing several impacts, could separate from the frame. This separation is due to the edge of the sheet element being able to move towards an obtuse angle. Once the edge is at an obtuse angle the sheet element slips from the frame, or the edge of the sheet element exerts a force on a flange of the frame causing it to deform, releasing the locking member and the screen from the frame. Once the screen is detached from the frame an unauthorized person can access the opening across which the security screen is fitted. To overcome this vulnerability rivets are fitted to the security screen disclosed in patent AU2005252260 to secure it to the frame. The installation of rivets adds manufacturing time and cost to the security screen. In addition, the rivets can lead to corrosion due to dissimilar metals being in direct contact with each other.

The preceding discussion of the background art is intended to facilitate an understanding of the present disclosure only. The discussion is not an acknowledgement or admission that any of the material referred to is or was part of the common general knowledge as at the priority date of the application.

### SUMMARY OF THE DISCLOSURE

It is an object of this disclosure to provide a security screen which ameliorates, mitigates or overcomes, at least one disadvantage of the prior art, or which will at least provide the public with a practical choice.

Throughout the specification the term ‘opening’ is used to describe a doorway, window, or hole/void within a structure which needs to be secured.

The present disclosure provides a security screen for securing an opening in a structure, the security screen comprising a frame defining an open portion and a sheet element received across the open portion of the frame, the sheet element comprises a planar portion and an edge portion which extends around at least part of the perimeter of the planar portion, at least part of the edge portion provides a lip which is oriented at an acute angle to the planar portion, the edge portion is received in a cavity in the frame and cooperates with a locking member to lock the edge portion in the cavity wherein the cavity enables the lip to maintain an orientation which is at an acute angle to the planar portion, the locking member having a first end section adjacent the open portion, and a second end section encapsulated in a slot formed in an internal wall of the frame, substantially restricting rotational movement of the locking member.

With this arrangement movement of the locking member is restricted to movement along one of its axes. With no, or minimal, rotational movement, the action of the locking member to lock the edge portion in the cavity is not compromised.

The present disclosure further provides a security screen for securing an opening in a structure, the security screen comprising a frame defining an open portion and a sheet element received across the open portion of the frame, the sheet element comprises a planar portion and an edge portion which extends around at least part of the perimeter of the planar portion, at least part of the edge portion provides a lip which is oriented at an acute angle to the planar portion, the edge portion is received in a cavity in the frame and cooperates with a locking member to lock the edge portion in the cavity wherein the cavity enables the lip to maintain an orientation which is at an acute angle to the planar portion.

The edge portion may extend partially, substantially or entirely around the perimeter of the planar portion.

The lip may extend partially, substantially or entirely around the edge portion.

In one aspect of the disclosure, the planar portion, edge portion and lip are integrally formed from a single sheet material to provide the sheet element. The lip may be caused to form the acute angle to the planar portion, such as by bending the single sheet material.

In another aspect of the disclosure, the lip is separately secured to the edge portion so as to be at an acute angle to the planar portion.

The frame may be formed from a plurality of frame members, such as four frame members when configuring a rectangular or square security screen.

Each frame member may comprise an inner edge which cooperates with the inner edge of the other frame members to define the open portion of the frame, an external flange which provides an external surface of the security screen, and an inner flange which provides an internal surface of the security screen and is typically adjacent the structure when the security screen is installed. Each frame member may also comprise a leg which extends inwardly from the inner edge away from the open portion.

The cavity of the frame comprises a channel for receiving the locking member, and a void. The channel is defined by an aperture in the inner edge of the frame, an internal surface of the inner flange, an internal surface of the leg, the void, and a slot formed in an internal wall of the frame.

The locking member may be substantially rotatably fixed relative to the frame.

The channel may substantially limit/prevent the ability for the locking member to rotate relative to the frame.

The locking member may be of an elongate cross section. The cross-sectional length of the locking member may be similar to the length of the channel such that when the locking member is received in the channel, a first end section of the locking member is received in the slot and a surface of a second end section is substantially flush to or spaced inwardly from the inner edge of the frame. The slot houses the first end section of the elongate member such that the first end section can only be withdrawn from the slot by moving the locking member outwardly from the channel in a direction which is parallel to the longitudinal axis of the channel. The slot may encapsulate the first end section of the elongate member. As a result, any forces acting on the locking member transverse to its longitudinal axis will be transferred through the slot into the frame. This limits/prevents the ability of the locking member to rotate relative to the frame. When the sheet element exerts a force on the locking member along a plane at an angle to the longitudinal axis of the locking member, such as may occur when there is an impact on the sheet element, the locking member is not free to rotate. Instead the force is distributed within the frame through the internal wall of the frame in which the slot is formed. This ensures the locking action of the locking member on the sheet element is not compromised.

The locking member has a gripping means in a surface thereof such that the gripping means is adjacent the internal surface of the inner flange when the locking member is received in the cavity. The internal surface of the inner flange may also provide a similar gripping means and is positioned such that it mates with the gripping means on the locking member when the locking member is received in the cavity. The gripping means may be in the form of serrations, a roughened surface, knurling or may take other forms as would be known to a person skilled in the art. Preferably the gripping means allows the locking member to be readily inserted into the cavity while preventing the locking member from being readily removed therefrom.

The aperture in the inner edge of the frame may be of suitable width to accommodate the thickness of the sheet element and the locking member such that when the locking member is received therein the sheet element is clampingly secured between the leg of the frame and the locking member.

The void may be defined by the channel, the internal wall, the external flange, the inner edge and the leg. A gap is formed between a distal end of the leg from the inner edge of the frame, and an internal surface of the internal wall.

The void may receive the lip of the edge portion. The lip may enter the void through the gap.

Preferably the depth of the void is less than the length of the lip. The distance between the channel and an inner surface of the external surface may be less than the length of the lip.

Preferably the length of the void is less than the length of the channel. The distance between the inner edge of the frame and the internal surface of the internal wall may be less than the length of the channel.

The angle of the lip relative to the planar portion of the sheet element may be less than 45°. The angle of the lip relative to the planar portion of the sheet element may be less than 25°.

Preferably the security screen is assembled such that the lip is spaced away from the distal end of the leg, towards the internal surface of the internal wall. The edge portion of the sheet element may lie adjacent or be in abutment with the internal surface of the internal wall.

Upon impact of a significant force on the sheet element, the edge portion of the sheet element may be caused to move towards the inner edge of the frame until the lip engages the distal end of the leg.

The leg may provide a ramped surface at the distal end.

The present disclosure further provides a security screen, the security screen comprising a frame defining an open portion and a sheet element secured across the open portion of the frame, the sheet element comprises an edge portion secured to the frame, the edge portion provides a lip which is oriented at an acute angle to the sheet element, the edge portion is received in a cavity in the frame and cooperates with a locking member to lock the edge portion in the cavity wherein the cavity retains the lip in an orientation which is at an acute angle to the sheet element.

The present disclosure provides a security screen fastening system for securing an edge portion of a sheet element, such as a mesh sheet, to a frame portion of the security screen, the edge portion provides a lip which is oriented at an acute angle to the sheet element, the edge portion is received in a cavity in the frame portion and cooperates with a locking member to lock the edge portion in the cavity wherein the cavity retains the lip in an orientation which is at an acute angle to the sheet element.

The present disclosure further provides a security screen, the security screen comprising a frame defining an open portion and a sheet element secured across the open portion of the frame, the sheet element comprises an edge portion secured to the frame, the edge portion provides a lip which is oriented at an acute angle to the sheet element, the edge portion is received in a cavity in the frame and cooperates with a locking member to lock the edge portion in the cavity wherein the cavity retains the lip in an orientation which is at an acute angle to the sheet element, the locking member having an end section encapsulated in the frame to substantially prevent rotational movement of the locking member.

The present disclosure provides a security screen fastening system for securing an edge portion of a sheet element, such as a mesh sheet, to a frame portion of the security screen, the edge portion provides a lip which is oriented at an acute angle to the sheet element, the edge portion is received in a cavity in the frame portion and cooperates with a locking member to lock the edge portion in the cavity wherein the cavity retains the lip in an orientation which is at an acute angle to the sheet element, the locking member having an end section encapsulated in the frame to substantially prevent rotational movement of the locking member.

The sheet element may be planar in shape.

The edge portion may be co-planar with the sheet element.

The present disclosure further provides a security screen for securing an opening, the security screen comprising a frame defining an open portion and a sheet element received across the open portion of the frame, the sheet element comprises a planar portion and an edge portion which extends around the perimeter of the planar portion, the edge portion provides a lip which is at an acute angle to the planar portion, the edge portion is received in a cavity in the frame wherein the cavity maintains the lip at an acute angle to the planar portion regardless of an impact thereon.

The present disclosure further provides a security screen comprising:
a frame having an outer edge which defines the outer perimeter of the frame, and having an inner edge which surrounds an open portion of the frame, the outer edge of the frame being dimensioned such that in use the security screen is receivable across an opening to secure the opening,
a sheet element received in the open portion of the frame to close the open portion, an edge portion of the sheet element being formed with a lip which is at an acute angle relative to a planar portion of the sheet element,
the inner edge of the frame formed with a channel having an entry tending across at least a portion of the width of the inner edge, the channel extending along the inner edge, the channel having two opposed side faces extending from the inner edge, one side face of the channel having a void located inward of the inner edge and extending laterally from the channel wherein the width of the void is less than the length of the lip, the lip of the sheet element is received through the channel such that the lip is positioned within the void,
a locking member fixed within the channel clampingly secures the sheet element relative to the other side face of the channel to close the space between the sheet element and the other side face.

Preferably the locking member is fixed in the channel at least in part, through the frictional inter-engagement between the locking member and the other side face.

Preferably the locking member is fixed in the channel at least in part through the inter-engagement of complementary formations provided on the opposed face of the channel and opposed face of the locking member.

Preferably the complementary formations comprise serrated-like formations or corrugated-like configurations on the opposed face of the channel and opposed face of the locking member.

The retention of the locking member in the channel may be supplemented by fixing elements between the locking member and the frame.

The locking member may substantially fill the space defined within the channel between the lip and the inner edge, between the other face of the sheet element and the other side face of the channel.

The locking member may be formed of increasing thickness such that once assembled it is wedgingly engaged between the other side face of the channel and the other face of the sheet element.

A layer of an insulator may be located over the edge portion of the sheet element to improve corrosion resistance.

Preferably the sheet element is in the form of a perforated sheet. The perforated sheet may be formed of a non-expanded steel sheet having a thickness sufficient to withstand penetration as a result of impact by blunt objects and having a plurality of closely spaced apertures punched therein which are dimensioned to prevent insect access through the apertures, wherein the spacing of the apertures provides a substantially unrestricted view through the sheet element.

The perforate sheet element may be formed of stainless steel sheet.

According to an alternative preferred feature of the disclosure the perforate sheet element is formed of a woven mesh.

According to an alternative preferred feature of the disclosure the perforate sheet element is formed of an expanded mesh.

According to an alternative preferred feature of the disclosure the perforate sheet element is powder coated.

The present disclosure further provides a security screen as herein described wherein the opening is a window and the closure comprises the security screen receivable across the window.

The closure may be selectively moved between an open and closed position across the window.

The present disclosure further provides a security screen as herein described wherein the opening is a doorway and the closure comprises a door which can be selectively moved between an open and closed position across the doorway.

The present disclosure further provides a security screen for securing an opening in a structure, the security screen comprising a frame defining an open portion and a sheet element received across the open portion of the frame, the sheet element comprises a planar portion and an edge portion which extends around at least part of the perimeter of the planar portion, at least part of the edge portion provides a lip which is oriented at an acute angle to the planar portion, the edge portion is received in a cavity in the frame, the cavity comprises a channel and a void, wherein the channel cooperates with a locking member to lock the edge portion in the cavity such that the lip extends into the void, wherein the lip is spaced from an inwardly extending leg of the frame and maintains an orientation which is at an acute angle to the planar portion of the sheet element, the locking member having a first end section adjacent the open portion, and a second end section encapsulated in a slot formed in an internal wall of the frame, substantially restricting rotational movement of the locking member.

The present disclosure further provides a security screen for securing an opening in a structure, the security screen comprising a frame defining an open portion and a sheet element received across the open portion of the frame, the sheet element comprises a planar portion and an edge portion which extends around at least part of the perimeter of the planar portion, at least part of the edge portion provides a lip which extends from a first side of the edge portion such that it is oriented at an acute angle to the planar portion of the sheet element, the edge portion is received in a cavity in the frame whereby a second side of the edge portion cooperates with a locking member to lock the edge portion in the cavity wherein the cavity enables the lip to maintain an orientation which is at an acute angle to the planar portion.

The present disclosure further provides a security screen, the security screen comprising a frame defining an open portion and a sheet element secured across the open portion of the frame, the sheet element comprises an edge portion secured to the frame, the edge portion provides a lip which extends away from a first side of the edge portion such that it is oriented at an acute angle to the sheet element, the edge portion is received in a cavity in the frame, the cavity comprises a channel and a void, wherein a second side of the edge portion cooperates with a locking member and the channel to lock the edge portion relative to the frame wherein the void retains the lip in an orientation which is at an acute angle to the sheet element.

The present disclosure further provides a security screen, the security screen comprising a frame defining an open portion and a sheet element secured across the open portion of the frame, the sheet element comprises an edge portion secured to the frame, the edge portion provides a lip which is oriented at an acute angle to the sheet element, the edge portion is received in a cavity in the frame, the cavity comprises a channel and a void, wherein the edge portion cooperates with a locking member to lock the edge portion in the cavity wherein the channel receives the locking member and the void receives and retains the lip in an orientation which is at an acute angle to the sheet element, the locking member having an end section encapsulated in the frame to substantially prevent rotational movement of the locking member.

The present disclosure further provides a security screen for securing an opening, the security screen comprising a frame defining an open portion and a sheet element received across the open portion of the frame, the sheet element comprises a planar portion and an edge portion which extends around the perimeter of the planar portion, the edge portion provides a lip which is at an acute angle to the planar portion, the edge portion is received in a cavity in the frame wherein a void of the cavity receives the lip such that it maintains the lip at an acute angle to the planar portion regardless of an impact thereon.

The present disclosure further provides a security screen comprising:
a frame having an outer edge which defines the outer perimeter of the frame, and having an inner edge which surrounds an open portion of the frame, the outer edge of the frame being dimensioned such that in use the security screen is receivable across an opening to secure the opening,
a sheet element received in the open portion of the frame to close the open portion, an edge portion of the sheet element being formed with a lip which is at an acute angle relative to a planar portion of the sheet element,
the inner edge of the frame incorporates a cavity comprising a channel and a void, the frame is formed with the channel having an entry tending across at least a portion of the width of the inner edge, the channel extending along the inner edge, the channel having two opposed side faces extending from the inner edge, one side face of the channel opens into the void, the void is located inward of the inner edge and extending laterally from the channel wherein the width of the void is less than the length of the lip, the lip of the sheet element is positioned within the void,
a locking member fixed within the channel clampingly secures the sheet element relative to the other side face of the channel to close the space between the sheet element and the other side face.

The present disclosure further provides a security screen fastening system for securing an edge portion of a sheet element, such as a mesh sheet, to a frame portion of the security screen, the edge portion provides a lip which is oriented at an acute angle to the sheet element, the edge portion is received in a cavity in the frame portion, the cavity comprises a channel and a void, the edge portion cooperates with a locking member to lock the edge portion in the cavity wherein the void receives and retains the lip in an orientation which is at an acute angle to the sheet element.

The present disclosure further provides a security screen fastening system for securing an edge portion of a sheet element, such as a mesh sheet, to a frame portion of the security screen, the edge portion provides a lip which is oriented at an acute angle to the sheet element, the edge portion is received in a cavity in the frame portion, the cavity comprises a channel and a void, the edge portion cooperates with a locking member to lock the edge portion in the cavity wherein the locking member is received in the channel and the void receives and retains the lip in an orientation which is at an acute angle to the sheet element, the locking member having an end section encapsulated in the frame to substantially prevent rotational movement of the locking member.

### BRIEF DESCRIPTION OF THE DRAWINGS

Further features of the present disclosure are more fully described in the following description of a non-limiting embodiment(s) thereof. This description is included solely for the purposes of exemplifying the present disclosure. It should not be understood as a restriction on the broad summary, disclosure or description of the disclosure as set out herein. The description will be made with reference to the accompanying drawings in which:

FIG. 1 is a cross section of a security screen according to a first embodiment of the present disclosure showing a screen element in a normal condition;

FIG. 2 is a cross section of a side section of FIG. 1 showing a frame and a portion of the sheet element;

FIG. 3 is a cross section of a side section of the frame shown in FIG. 1;

FIG. 4 is a cross section of the security screen shown in FIG. 1 showing the screen in an after impact condition; and

FIG. 5 is a cross section of a side section of FIG. 4.

In the drawings like structures are referred to by like numerals throughout the several views. The drawings shown are not necessarily to scale, with emphasis instead generally being placed upon illustrating the principles of the present disclosure.

### DETAILED DESCRIPTION OF THE PREFERRED EMBODIMENT

Referring to the figures, the disclosure according to a first embodiment is in the form of a security screen 10. The security screen 10 is adapted to be mounted/fitted to an opening, such as a doorway or a window in a structure, to prevent unauthorized entry, while allowing air and light to pass therethrough without overly restricting vision.

Security screens installed in cyclone/typhoon/hurricane prone locations are also required to withstand higher levels of impact due to flying debris. This impact can be 2500 joules or more. Screens that are currently manufactured by the patentee in accordance with patent AU2005252260 require additional rivets through the frame and into the screen material. Tested samples of the present disclosure have proven that the disclosure withstands multiple impacts of 2500 joules without any additional fasteners, such as rivets, to fix the frame to the screen material/sheet element.

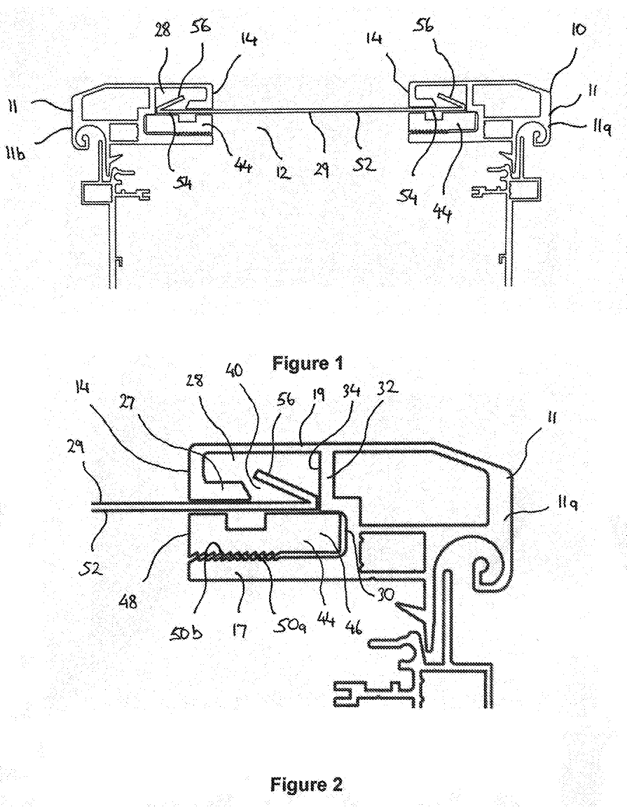

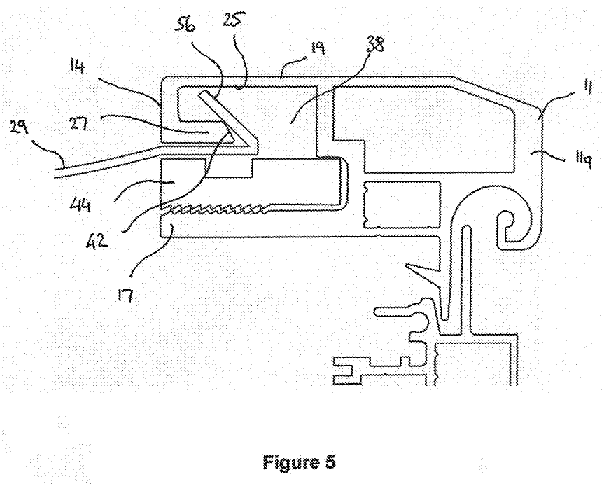

FIGS. 1 and 2 show the security screen 10 according to the first embodiment ready for installation across an opening, while FIGS. 4 and 5 show the security screen 10 after being exposed to an impact.

The security screen 10 comprises a frame 11 which defines the perimeter of the security screen 10. The frame 11 comprises an upper and lower frame member (not shown) and lateral side frame members 11a, 11b which cooperate to generally define a rectangular open portion 12 therebetween. The frame members are identical in their cross-sectional profile but pairs may differ in length.

The open portion 12 defined by the frame 11 is closed by a sheet element 29 which is secured within/by the frame 11. The sheet element 29 can be formed of mesh, perforated sheet, expanded metal or the like, and is formed of material which is resistant to impact by blunt objects in order to provide a security barrier.

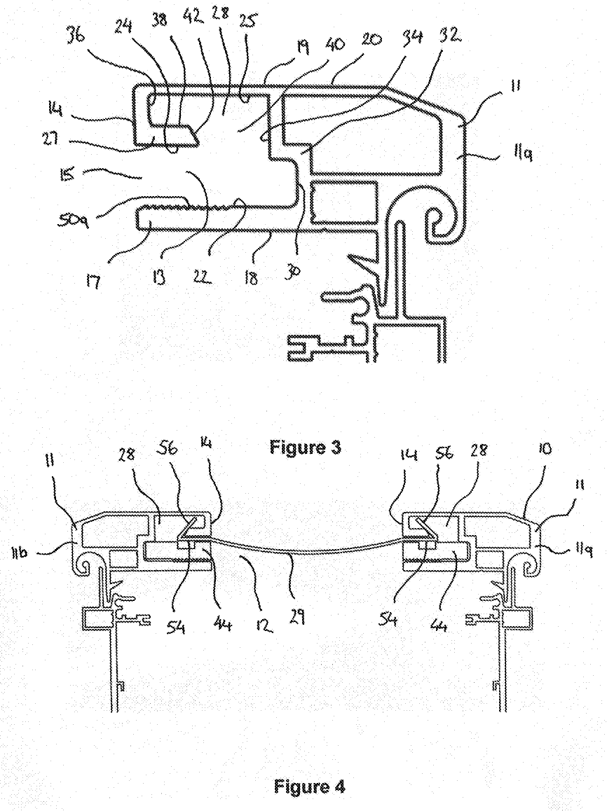

Referring to FIG. 3, each frame member 11a, 11b comprises an inner edge 14 which defines the open portion 12, an external flange 19 which provides an external surface 20 of the security screen 10 and an inner flange 17 which provides an internal surface 18 of the security screen 10. The internal surface 18 is placed adjacent the structure when the security screen 10 is installed.

Each frame member 11a, 11b incorporates a cavity formed by a channel 13 and a void 28.

Each frame member 11a, 11b also comprises a leg 27 which extends inwardly from the inner edge 14 away from the open portion 12.

The channel 13 extends inwardly into the frame member 11a, 11b from an aperture 15 provided in the inner edge 14 of the frame member 11a,11b. The channel 13 is defined by the aperture 15 in the inner edge 14 of the frame, an internal surface 22 of the inner flange 17, an internal surface 24 of the leg 27, the void 28, and a slot 30 formed in an internal wall 32 of the frame 11.

The void 28 is shorter in length than the channel 13. The void 28 is defined by the channel 13, an internal surface 34 of the internal wall 32, an internal surface 25 of the external flange 19, an internal surface 36 of the inner edge 14 and an internal surface 38 of the leg 27. A gap 40 is formed between a distal end 42 of the leg 27, and the internal surface 34 of the internal wall 32.

The channel 13 receives a locking member 44 wherein the locking member 44 slides inwardly into the channel 13 through the aperture 15. The locking member 44 is of an elongate cross section, wherein the length of the locking member 44 is such that when the locking member 44 is received in the channel 13 a first end section 46 of the locking member 44 is received in the slot 30 and a surface 48 of a second end section 47 is substantially flush with the inner edge 14 of the frame, as best shown in FIG. 2. The slot 30 houses the first end section 46 of the elongate member such that the locking member 44 can only be withdrawn from the channel 13 by moving the locking member 44 outwardly from the channel 13 in a direction which is parallel to the longitudinal axis of the channel 13. As a result of the support of the slot 30 on the locking member 44 any forces acting on the locking member 44 transverse to its longitudinal axis will be transferred into the frame 11.

The internal surface 22 of the inner flange 17 has gripping means in the form of a serrated configuration 50a. The locking member 44 also has a complementary gripping means in the form of a serrated configuration 50b. Upon insertion of the locking member 44 in the channel 13, the serrated configuration 50b of the locking member 44 aligns and interacts with the serrated configuration 50a of the inner flange 17 to hold the locking member 44 in place. The complementary serrated configurations 50a, 50b enable insertion of the locking member 44 into the channel 13 but restrict outward movement of the locking member 44 from the channel 13.

The sheet element 29 comprises a planar portion 52 and an edge portion 54 which extends around the perimeter of the planar portion 52. The edge portion 54 includes a lip 56 which is oriented at an acute angle to the planar portion 52 and the remainder of the edge portion 54. In this embodiment the lip is at an angle of 25° to the edge portion 54. The lip 56 is longer in length than the depth of the void 28 (i.e. the distance between the gap 40 and the internal surface 25 of the external flange).

During assembly of the security screen 10, the edge portion 54 is received in the channel 13 in the frame 11 until the lip 56 can be received into the void 28 through the gap 40. Once in position the locking member 44 can be placed into the channel 13 and inserted therein until the first end section 46 of the locking member 44 is received in the slot 30. The leg 27 then cooperates with the locking member 44 to clampingly secure the edge portion 54 whereupon the sheet element 29 is locked to the frame 11, as shown in FIG. 1.

The configuration of the sheet element 29 relative to the frame 11 when assembled for installation is as shown in FIG. 1. In this configuration the sheet element 29 is substantially planar between the frame members 11a, 11b and extends into the cavity such that the edge portion 54 of the screen element 29 is adjacent the internal surface 34 of the internal wall 32, and the lip 56 extends into the void 28, maintaining its acute angle relative to the screen element 29.

If the security screen 10 is exposed to a sufficient impact, or a sufficient number of impacts, the security screen 10 will absorb the impact and the sheet element 29 relative to the frame 11 will take a form as shown in FIG. 4. Upon impact the planar portion 52 of the screen element 29 between the frame members 11a, 11b bows inwardly and the lip 56 is caused to move towards the distal end 42 of the leg 27, which in this embodiment is ramped. Additional impact on the sheet element 29 will eventually cause the lip 56 to engage the distal end 42 of the leg 27. Once the lip 56 engages the distal end 42, and noting that the length of the lip 56 is longer than the depth of the void 28, the distal end 42 will cause the angle of the lip relative to the edge portion 54 to begin to increase, until the edge of the lip 56 engages the internal surface 25 of the external flange 19. At this point, owing to the length of the lip relative to the depth of the void 28, the internal surface 25 prevents the lip 56 from further rotational movement. The internal surface 25 of the external flange 19 ensures the lip 56 maintains an acute angle relative to the edge portion 54, and prevents the edge portion 54 of the screen sheet 29 from being further extracted from the frame 11. The lip 56 is effectively locked from further rotational movement due to its engagement with the internal surface 25 of the external flange 19 and the distal end 42 of the leg 27. When the lip 56 is in this arrangement the edge portion 54 is prevented from extraction from the frame 11.

Upon experiencing an impact, a force is exerted via the screen sheet 29 to the second end section 47 of the locking member 44 whereupon the locking member 44 experiences a moment/rotational force. This could have the effect of causing the locking member 44 to tilt relative to the frame, reducing the clamping action upon the sheet element 29, and permitting the sheet element 29 to loosen relative to/detach from the frame. In the present embodiment this is mitigated by preventing, or substantially limiting, the ability of the locking member 44 to rotate relative to the frame. In particular, the slot 30 receives and encapsulates the first end section 46 of the locking member 44 such that any rotational force exerted on the second end section 47 of the locking member 44 is distributed into the frame. The slot 30 limits the ability of the locking member 44 to rotate, ensuring the clamping action between the locking member 44 and the frame on the screen sheet 29 is not compromised and the screen sheet 29 remains secured to the frame 10.

Modifications and variations such as would be apparent to the skilled addressee are considered to fall within the scope of the present disclosure.

The present disclosure is not to be limited in scope by any of the specific embodiments described herein. These embodiments are intended for the purpose of exemplification only. Functionally equivalent products, formulations and methods are clearly within the scope of the disclosure as described herein. It will be understood by those skilled in the art that various changes in form and details may be made therein without departing from the spirit and scope of the disclosure as defined by the appended claims.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

It will be understood that when an element is referred to as being “on”, “engaged”, “connected” or “coupled” to another element/layer, it may be directly on, engaged, connected or coupled to the other element/layer or intervening elements/layers may be present. Other words used to describe the relationship between elements/layers should be interpreted in a like fashion (e.g., “between”, “adjacent”). As used herein the term “and/or” includes any and all combinations of one or more of the associated listed items.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprise”, “comprises,” “comprising,” “including,” and “having,” or variations thereof are inclusive and therefore specify the presence of stated features, integers, steps, operations, elements, and/or components, but do not preclude the presence or addition of one or more other features, integers, steps, operations, elements, components, and/or groups thereof.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

1.-44. (canceled)

45. A security screen for securing an opening in a structure, the security screen comprising a frame defining an open portion and a sheet element received across the open portion of the frame, a frame member comprises a leg which extends inwardly from an inner edge away from the open portion, the sheet element comprises a planar portion and an edge portion which extends around at least part of the perimeter of the planar portion, at least part of the edge portion provides a lip which extends from a first side of the edge portion such that it is oriented at an acute angle to the planar portion of the sheet element, the edge portion is received in a cavity in the frame whereby a second side of the edge portion cooperates with a locking member to lock the edge portion of the sheet element in the cavity wherein the cavity enables the lip to maintain an orientation which is at an acute angle to the planar portion.

46. The security screen of claim 45, wherein the edge portion extends partially, substantially or entirely around the perimeter of the planar portion.

47. The security screen of claim 45, wherein the lip extends partially, substantially or entirely around the edge portion.

48. The security screen of claim 45, wherein the planar portion, edge portion and lip are integrally formed from a single sheet material to provide the sheet element, alternatively the lip is separately secured to the edge portion so as to be at an acute angle to the planar portion.

49. The security screen of claim 45, wherein the frame is formed from a plurality of frame members wherein each frame member comprises the inner edge which cooperates with the inner edge of the other frame members to define the open portion of the frame, an external flange which provides an external surface of the security screen, and an inner flange which provides an internal surface of the security screen.

50. The security screen of claim 45, wherein the locking member is substantially rotatably fixed relative to the frame.

51. The security screen of claim 49, wherein the cavity of the frame comprises a channel for receiving the locking member, and a void wherein the channel is defined by an aperture in the inner edge of the frame, an internal surface of the inner flange, an internal surface of the leg, the void, and a slot formed in an internal wall of the frame, wherein the void is defined by the channel, the internal wall, the external flange, the inner edge and the leg.

52. The security screen of claim 51, wherein the locking member is of an elongate cross section, wherein the cross-sectional length of the locking member is similar to the length of the channel such that when the locking member is received in the channel, a first end section of the locking member is received in the slot and a surface of a second end section is substantially flush to or spaced inwardly from the inner edge of the frame wherein the slot houses the first end section of the locking member such that the first end section can only be withdrawn from the slot by moving the locking member outwardly from the channel in a direction which is parallel to a longitudinal axis of the channel.

53. The security screen of claim 49, wherein the locking member has a gripping means in a surface thereof such that the gripping means is adjacent the internal surface of the inner flange when the locking member is received in the cavity wherein the internal surface of the inner flange provides a complementary gripping means and is positioned such that it mates with the gripping means on the locking member when the locking member is received in the cavity.

54. The security screen of claim 51, wherein the aperture in the inner edge of the frame is of suitable width to accommodate the thickness of the sheet element and the locking member such that when the locking member is received therein the sheet element is clampingly secured between the leg of the frame and the locking member.

55. The security screen of claim 51, wherein a gap is formed between a distal end of the leg from the inner edge of the frame, and an internal surface of the internal wall.

56. The security screen of claim 51, wherein the void receives the lip of the edge portion.

57. The security screen of claim 51, wherein the distance between the channel and an inner surface of the external surface is less than the length of the lip.

58. The security screen of claim 45, wherein the leg provides a ramped surface at a distal end of the leg.

59. A security screen, the security screen comprising a frame defining an open portion and a sheet element secured across the open portion of the frame, the frame comprises a leg which extends inwardly from an inner edge of the frame away from the open portion, the sheet element comprises an edge portion secured to the frame, the edge portion provides a lip spaced from the leg and which extends away from a first side of the edge portion such that it is oriented at an acute angle to the sheet element, the edge portion is received in a cavity in the frame, the cavity comprises a channel and a void, wherein a second side of the edge portion cooperates with a locking member and the channel to lock the edge portion of the sheet element relative to the frame wherein the void retains the lip in an orientation which is at an acute angle to the sheet element.

60. A security screen for securing an opening, the security screen comprising a frame defining an open portion and a sheet element received across the open portion of the frame, the frame comprises a leg which extends inwardly from an inner edge of the frame away from the open portion, the sheet element comprises a planar portion and an edge portion which extends around the perimeter of the planar portion, the edge portion provides a lip spaced from the leg and which is at an acute angle to the planar portion, the edge portion of the sheet element is received in a cavity in the frame and clampingly secured between the leg and a locking member, wherein a void of the cavity receives the lip such that it maintains the lip at an acute angle to the planar portion regardless of an impact thereon.

61. The security screen of claim 60, wherein the locking member is fixed in a channel of the frame at least in part, through a frictional inter-engagement between the locking member and an other side face of the channel alternatively, wherein the locking member is fixed in the channel at least in part through the frictional inter-engagement of complementary formations provided on the other side face of the channel and an opposed face of the locking member.

62. The security screen of claim 60, wherein the locking member substantially fills a space defined within the channel between the lip and the inner edge, between an other face of the sheet element and an other side face of the channel.

63. The security screen according to claim 62, wherein the locking member is formed of increasing thickness such that, once assembled, the locking member is wedgingly engaged between an other side face of the channel and an other face of the sheet element.

64. A security screen fastening system for securing an edge portion of a sheet element, such as a mesh sheet, to a frame portion of the security screen, the frame portion comprises a leg which extends inwardly from an inner edge of the frame portion away from an open portion across which spans the sheet element, the edge portion provides a lip which is spaced from the leg and is oriented at an acute angle to the sheet element, the edge portion is received in a cavity in the frame portion, the cavity comprises a channel and a void, the edge portion cooperates with the leg and a locking member to lock the edge portion of the sheet element in the cavity wherein the void receives and retains the lip in an orientation which is at an acute angle to the sheet element.
